(19) United States
(12) Patent Application Publication
(10) Pub. No.: US 2025/0041890 A1
(43) Pub. Date: Feb. 6, 2025

(54) Coating Apparatus

(71) Applicant: Taikisha Ltd., Tokyo (JP)

(72) Inventors: Kenji Sakita, Tokyo (JP); Ryuto Akaogi, Tokyo (JP); Takuya Sekigawa, Tokyo (JP)

(21) Appl. No.: 18/788,280

(22) Filed: Jul. 30, 2024

(30) Foreign Application Priority Data
Jul. 31, 2023 (JP) 2023-124362

(51) Int. Cl. B05B 16/00

(52) U.S. Cl. CPC B05B 16/95

(57) ABSTRACT

A coating apparatus includes a coating booth configured to coat with a coating material a coating target being conveyed, the coating booth having an opening disposed in a portion of a lower face of the coating booth and configured to discharge air containing coating material mist, the portion being central in a width direction of the coating booth, the width direction being horizontally orthogonal to a direction in which the coating target is conveyed; a remover device disposed below the coating booth and within an area of the coating booth in the width direction and configured to receive from the coating booth the air containing the coating material mist and remove the coating material mist; and a first connection path connecting the opening to the remover device.

### CROSS-REFERENCE TO RELATED APPLICATION

This application claims priority to Japanese Patent Application No. 2023-124362 filed Jul. 31, 2023, the disclosure of which is hereby incorporated by reference in its entirety.

### BACKGROUND OF THE INVENTION

### Field of the Invention

The present invention relates to a coating apparatus including a coating booth and a remover device disposed in a space below the coating booth and configured to remove coating material mist.

### Description of Related Art

A coating apparatus that includes a coating booth and a remover device disposed in a space below the coating booth and configured to remove coating material mist from air discharged from the coating booth has been known. For example, US Patent Application Publication No. 2016/0288036 discloses a coating apparatus including a coating chamber and two filter modules disposed directly below the coating chamber, contained in respective filter module containers, and facing each other with reference to a vertical, longitudinal central plane of the coating chamber.

US Patent Application Publication No. 2016/0288036 discloses in FIG. 1 a coating apparatus configured as follows: The filter modules each include a main filter device with an air introducing port on a side face on the side away from the vertical, longitudinal central plane (that is, on the outer side in the width direction of the coating chamber). The coating apparatus causes air discharged through the floor of the coating chamber to pass through a supply port disposed on the ceiling of each filter module container and above the air introducing port. The coating apparatus then causes the air to pass through the air introducing port into the main filter device.

US Patent Application Publication No. 2016/0288036 discloses in FIG. 11 a coating apparatus configured as follows: The filter modules each include a main filter device with an air introducing port on a side face on the side toward the vertical, longitudinal central plane (that is, on the inner side in the width direction of the coating chamber). The coating apparatus causes air discharged through the floor of the coating chamber to pass through a path between the two mutually facing main filter devices. The coating apparatus then causes the air to pass through the air introducing port into each main filter device.

Each coating apparatus disclosed in US Patent Application Publication No. 2016/0288036 includes a coating chamber with a floor that allows air passage over its entire width. The coating apparatus disclosed in each of FIGS. 1 and 11 of US Patent Application Publication No. 2016/0288036 thus operates to form a substantially linear air path extending from a portion of the floor of the coating chamber to the air introducing port of each main filter device, the portion being substantially directly above the air introducing port. Such a substantially linear air path has only a small resistance to airflow so that a change in the amount of air at a portion of the path likely affects the entire path. This means that for each coating apparatus disclosed in US Patent Application Publication No. 2016/0288036, if the amount of air that a main filter device processes is decreased due to a clog or the like, it tends to disturb airflow in the coating chamber, potentially leading to a decrease in the quality of the coating work.

### SUMMARY OF THE INVENTION

It is an object of the present invention to provide a coating apparatus configured to form a nonlinear path for mist-containing air from a coating booth to a remover device.

According to the present invention, there is provided a coating apparatus comprising
a coating booth configured to coat with a coating material a coating target being conveyed, the coating booth having an opening disposed in a portion of a lower face of the coating booth and configured to discharge air containing coating material mist, the portion being central in a width direction of the coating booth, the width direction being horizontally orthogonal to a direction in which the coating target is conveyed;
at least one remover device disposed below the coating booth and within an area of the coating booth in the width direction and configured to receive from the coating booth the air containing the coating material mist and remove the coating material mist; and
a first connection path connecting the opening to the at least one remover device,
the at least one remover device including an air introducing port disposed outward of the opening in the width direction, connected to the first connection path, and configured to receive from the first connection path the air containing the coating material mist.

Additional features and advantages of the present invention will be made clearer by the description of the exemplary and non-limiting embodiments below, which are described with reference to the drawings.

### BRIEF DESCRIPTION OF THE DRAWINGS

FIG. 1 is a diagram schematically illustrating the configuration of a coating apparatus.

FIG. 2 is a schematic cross-sectional view of the coating apparatus according to Embodiment 1 with a remover device at an operating position.

FIG. 3 is a schematic cross-sectional view of the coating apparatus according to Embodiment 1 with a remover device at a non-operating position.

FIG. 4 is a schematic cross-sectional view of a coating apparatus according to Embodiment 2 with a remover device at an operating position.

FIG. 5 is a schematic cross-sectional view of the coating apparatus according to Embodiment 2 with a remover device at a non-operating position.

### DESCRIPTION OF THE INVENTION

The description below deals with a coating apparatus as an embodiment of the present invention with reference to the drawings.

### First Embodiment

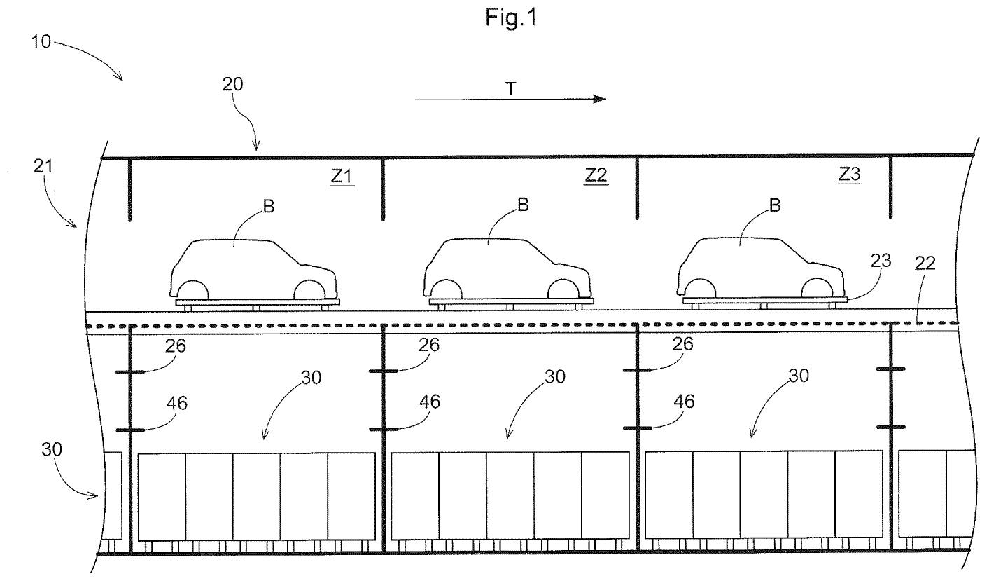

FIG. 1 is a diagram schematically illustrating the configuration of a coating apparatus. As illustrated in FIG. 1, the coating apparatus 10 includes a coating booth 20 and remover devices 30. The coating booth 20 includes a coating chamber 21 for coating targets B such as automobile bodies with a coating material. The remover devices 30 are each configured to remove coating material mist from air discharged from the coating chamber 21.

The coating chamber 21 includes two or more coating zones Z1, Z2, Z3, . . . arranged in the conveyance direction T in which the coating targets B are conveyed and corresponding to respective coating steps. The coating apparatus 10 includes a conveyor device 23 configured to convey the coating targets B from one coating zone Z1, Z2, Z3, . . . to the next in the order of the coating steps. The coating apparatus 10 also includes spray devices 24 each disposed on, for example, a side wall of the coating booth 20 and configured to spray a predetermined coating material onto the coating targets B conveyed into each coating zone Z1, Z2, Z3, . . . .

The coating booth 20 includes a top face with supply ports 25 provided for the respective coating zones Z1, Z2, Z3, . . . and configured to supply outside air. The supply of outside air through the supply ports 25 allows formation of a downward airflow in the respective coating zones Z1, Z2, Z3, . . . . The coating apparatus 10 includes a grating floor 22 configured to guide, to a bottom portion of the coating chamber 21, air containing coating material mist that did not adhere to the coating targets B.

The coating booth 20 includes a lower face with openings 26 provided for the respective coating zones Z1, Z2, Z3, . . . and configured to discharge air from the coating chamber 21. The openings 26 are each disposed at a central portion in a width direction W, which is horizontally orthogonal to the conveyance direction T, and each extend in the conveyance direction T. The coating booth 20 includes an air-blocking floor face as a portion of the lower face which is outward of the openings 26 in the width direction W. The term “central portion” as used herein refers to an area present on opposite sides in the width direction W relative to an imaginary center line C of the coating apparatus 10 and extending over a distance approximately 1% to 50% of the dimension of the lower face of the coating booth 20 in the width direction W. The openings 26 are each connected to a first connection path 41 (described later).

The coating apparatus 10 includes a control device (not illustrated in the drawings) configured to control the amount of outside air supplied through the supply ports 25 to adjust the amount of the downward airflow in each coating zone Z1, Z2, Z3, . . . so that the amount of the downward airflow is equal among the coating zones Z1, Z2, Z3, . . . or is appropriate in each coating zone Z1, Z2, Z3, . . . in correspondence with the coating step.

The coating booth 20 has lower spaces 40 at a lower portion thereof in correspondence with the respective coating zones Z1, Z2, Z3, . . . . The lower spaces 40 each have (i) a dimension in the width direction W which dimension is substantially equal to the dimension of the coating chamber 21 in the width direction W and (ii) a dimension in the conveyance direction T which dimension is substantially equal to the dimension of the corresponding one of the coating zones Z1, Z2, Z3, . . . in the conveyance direction T. In other words, the coating zones Z1, Z2, Z3, . . . each have a shape substantially identical in a plan view to that of the corresponding lower space 40, which is below the coating zone Z1, Z2, Z3, . . . .

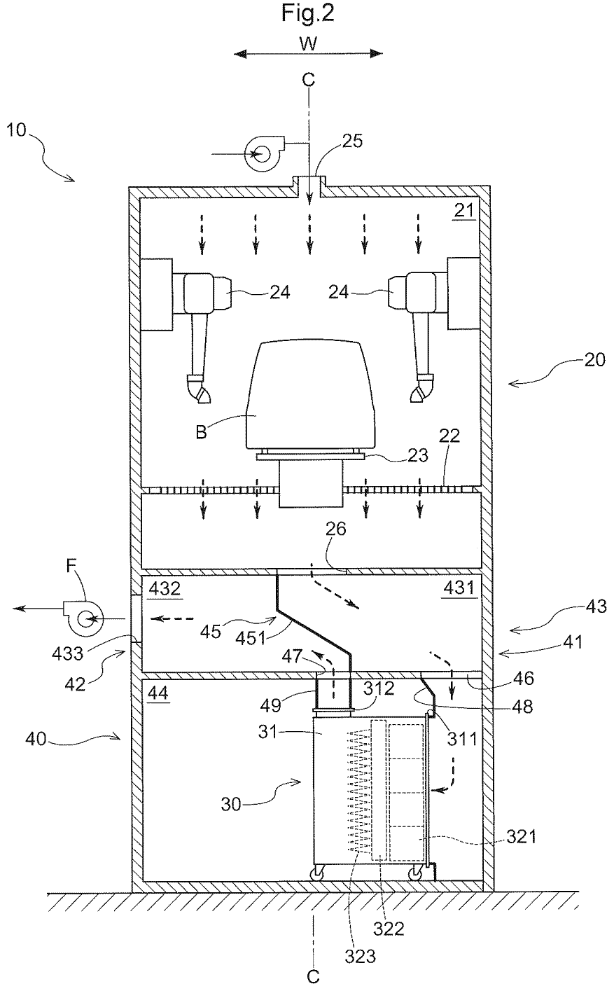

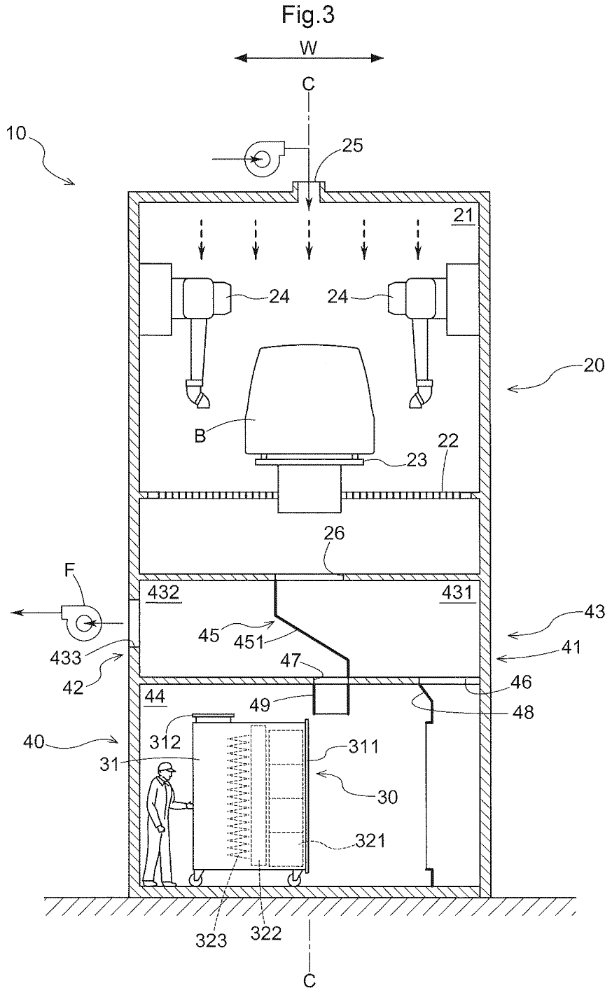

FIG. 2 is a schematic cross-sectional view of the coating apparatus as Embodiment 1 with a remover device at an operating position. FIG. 3 is a schematic cross-sectional view of the coating apparatus as Embodiment 1 with a remover device at a non-operating position. The coating apparatus 10 includes two or more (five for the present embodiment) remover devices 30 disposed in each lower space 40 and arranged in the conveyance direction T. The remover devices 30 are each movable in the width direction W between the operating position illustrated in FIG. 2 and the non-operating position illustrated in FIG. 3. The operating position refers to a position at which each remover device 30 is to receive air containing coating material mist and remove the coating material mist from the air. The non-operating position refers to a position at which each remover device 30 is to receive no air containing coating material mist and be maintained by a worker. For the present embodiment, the operating and non-operating positions of each remover device 30 are opposite to each other across the imaginary center line C. The operating position may alternatively overlap with the imaginary center line C, in which case each remover device 30 at the operating position straddles the imaginary center line C. The non-operating position may alternatively overlap with the imaginary center line C, in which case each remover device 30 at the non-operating position straddles the imaginary center line C.

The description below deals with how the remover devices 30 are configured. The description uses the term “far side” in relation to the width direction W to refer to the side of the operating position of a remover device 30 as viewed by a worker (see FIG. 3) present outward of the non-operating position in the width direction W and the term “near side” in relation to the width direction W to refer to the side of the non-operating position of a remover device 30 as viewed by the same worker.

The remover devices 30 each include a case 31 on casters as well as a primary filter element 321, a secondary filter element 322, and a tertiary filter element 323 each disposed in the case 31 and configured to remove coating material mist from air. The case 31 has an air introducing port 311 and an air discharge port 312. The air introducing port 311 is disposed on a side face of the case 31 on the far side in the width direction W and configured to introduce air containing coating material mist. The air discharge port 312 is disposed on a portion of the upper face of the case 31 which portion is on the near side in the width direction W and configured to discharge air from which coating material mist has been removed. The case 31 is not necessarily provided with casters, and may alternatively be moveable in the width direction W on a slide rail or the like.

The primary, secondary, and tertiary filter elements 321, 322, and 323 are arranged so that air introduced through the air introducing port 311 passes through the primary, secondary, and tertiary filter elements 321, 322, and 323 sequentially. For the present embodiment, the primary filter element 321 is a cardboard filter near the air introducing port 311; the secondary filter element 322 is a craft filter on the near side in the width direction W relative to the primary filter element 321; and the tertiary filter element 323 is a bag filter on the near side in the width direction W relative to the secondary filter element 322. The present invention may use any number of filter elements and any material for each filter element.

The coating apparatus 10 further includes a first connection path 41 and a second connection path 42 in each lower space 40. The first connection path 41 connects the air introducing port 311 of each remover device 30 at the operating position to the corresponding opening 26. The second connection path 42 connects the air discharge port 312 of each remover device 30 at the operating position to a discharge port 433 (described later). As described later, the first connection path 41 includes an upstream flow path 431, upstream connection ports 46, and an upstream collection duct 48, whereas the second connection path 42 includes a downstream duct 49, downstream connection ports 47, and a downstream flow path 432.

The lower spaces 40 each include an upper chamber 43 below the coating chamber 21 and in the shape of a substantially rectangular parallelepiped. The lower spaces 40 each include a partition wall 45 disposed at a substantially central portion in the width direction W and extending in the conveyance direction T to separate the corresponding upper chamber 43 into an upstream flow path 431 and a downstream flow path 432. The upstream flow path 431 is connected to the coating chamber 21 through the corresponding opening 26. The downstream flow path 432 has a discharge port 433 on a side face thereof on the outer side (that is, the near side) in the width direction W. The coating apparatus 10 includes a gas discharge fan F with a primary side to which the discharge port 433 is connected.

The lower spaces 40 each include a lower chamber 44 below the corresponding upper chamber 43 and in the shape of a substantially rectangular parallelepiped. The lower chamber 44 contains two or more remover devices 30. The lower chamber 44 communicates with the upper chamber 43 through upstream connection ports 46 at the boundary between the upper and lower chambers 43 and 44. The upstream connection ports 46 for the present embodiment are disposed on the outer side (that is, the far side) in the width direction W and apart from one another in the conveyance direction T. The upstream connection ports 46 may alternatively be connected to one another. The lower chamber 44 communicates with the upper chamber 43 through downstream connection ports 47 at the boundary between the upper and lower chambers 43 and 44. The downstream connection ports 47 for the present embodiment are disposed substantially at the center in the width direction W and apart from one another in the conveyance direction T.

The lower chamber 44 is provided with an upstream collection duct 48 extending from a top face thereof to its bottom face and connected to the upstream connection ports 46. The remover devices 30, when at the operating position, have their respective air introducing ports 311 disposed on the outer side (that is, the far side) in the width direction W relative to the corresponding opening 26 and coupled to a single upstream collection duct 48.

The lower chamber 44 is provided with a single downstream duct 49 suspended from its top face and coupled to the downstream connection ports 47. The remover devices 30, when at the operating position, have their respective air discharge ports 312 coupled to a single downstream duct 49 extending through all lower chambers.

The partition wall 45 for the present embodiment includes an airflow guide 451 configured to guide, toward the outer side (that is, the far side) in the width direction W, air containing coating material mist as discharged from the opening 26, which is at a central portion in the width direction, into the upstream flow path 431. The airflow guide 451 is directly below the opening 26, and extends linearly and at an angle so that the further away a portion thereof is from the opening 26, the closer it becomes to the air introducing port 311, which is connected to the first connection path 41. The upstream flow path 431, which is partially defined by the airflow guide 451, has a widening outward of a path linearly connecting the opening 26 to the upstream connection ports 46, however, the area of a surface orthogonal to the path (that is, the cross-sectional area of the upstream flow path 431) becomes larger and then smaller from the side of the opening 26 toward the upstream connection ports 46. The airflow guide 451 is not necessarily linear and may alternatively be in the shape of an arc or steps.

The description below deals with how each remover device 30, when at the operating position, removes coating material mist and how each remover device 30 is switched between the operating and non-operating positions.

During a coating operation for a coating target B, each corresponding remover device 30 is held at the operating position illustrated in FIG. 2. In this state, the coating apparatus 10 sends air containing coating material mist as generated in each coating zone Z1, Z2, Z3, . . . of the coating booth 20 through the corresponding first connection path 41 to two or more remover devices 30 provided for the corresponding coating zone Z1, Z2, Z3, . . . .

The coating apparatus 10 first causes air containing coating material mist to be discharged from each opening 26 in the coating booth 20 into the corresponding upstream flow path 431 and causes the air to flow to a bottom portion of the upstream flow path 431 as guided by the airflow guide 451 of the corresponding partition wall 45 toward the outer side (that is, the far side) in the width direction W. This causes a portion of the coating material mist to come into contact with and adhere to a wall face of the upstream flow path 431 to be removed from the air. The present embodiment is configured such that the variation in the cross-sectional area of the upstream flow path 431 causes a turbulent flow such as a swirl in the upstream flow path 431 to cause coating material mist to come into contact with and adhere to a wall face. The above configuration allows a large amount of coating material mist to be removed from the air. The cross-sectional area of the upstream flow path 431 varies, for instance, increases or decreases, from the side of the opening 26 toward the upstream connection ports 46. Coating material mist on a wall face of the upstream flow path 431 is removed during, for example, regular maintenance of the coating apparatus 10.

The coating apparatus 10 causes air containing coating material mist that has flown to the bottom portion of the upstream flow path 431 to be discharged from the upstream connection ports 46 into the upstream collection duct 48, and sends the air through the respective air introducing ports 311 into the corresponding remover devices 30. The coating apparatus 10 causes the air in each remover device 30 to pass through the primary, secondary, and tertiary filter elements 321, 322, and 323 sequentially to remove coating material mist from the air. The coating apparatus 10 causes the air, from which coating material mist has been removed, to be discharged from the respective air discharge ports 312 of the remover devices 30, and causes the air to flow through the second connection path 42 (namely, the downstream duct 49, the downstream connection ports 47, and the downstream flow path 432) and through the corresponding discharge port 433 to be discharged from the coating apparatus 10.

When the filter elements 321, 322, and 323 in a remover device 30 need replacing, a worker moves the remover device 30 to the non-operating position illustrated in FIG. 3. With the remover device 30 at the non-operating position, its air introducing port 311 and air discharge port 312 are apart and disconnected from the corresponding first and second connection paths 41 and 42, respectively. The upstream collection duct 48 includes shutters capable of being opened and closed and corresponding to the respective remover devices 30. Closing only the shutter corresponding to a remover device 30 that is moved to the non-operating position allows air containing coating material mist to keep flowing into each remover device 30 at the operating position. The coating apparatus 10 thus continues its coating operation while a remover device 30 including filter elements 321, 322, and 323 that need replacing is moved to the non-operating position. The worker performs maintenance work such as replacement of the filter elements 321, 322, and 323 through a door provided for the case 31, and then moves the remover device 30 back to the operating position to hold the remover device 30 at the operating position.

The present embodiment may be altered such that the remover devices 30 each have an air introducing port 311 not on a side face of its case 31 but on the upper face of the case 31 which is on the far side in the width direction W. In this case, the operating position for each remover device 30 may be a position at which its air introducing port 311 is under the corresponding upstream connection port 46 (that is, a position further on the far side in the width direction W than illustrated in FIG. 2). With the remover device 30 at the operating position, its air introducing port 311 is connected to the corresponding upstream flow path 431 through an upstream collection duct 48 suspended from the top face of the corresponding lower chamber 44 and coupled to the corresponding upstream connection ports 46.

### Second Embodiment

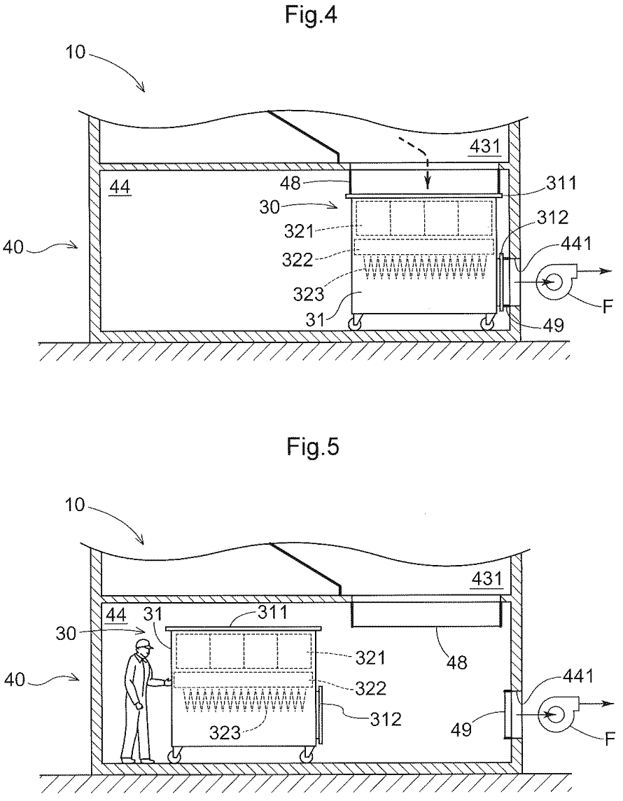

FIG. 4 is a schematic cross-sectional view of a coating apparatus as Embodiment 2 with a remover device at an operating position. FIG. 5 is a schematic cross-sectional view of the coating apparatus as Embodiment 2 with a remover device at a non-operating position. The coating apparatus 10 as the present embodiment is generally identical to Embodiment 1 except for the remover devices 30 and the first and second connection paths 41 and 42. The description below omits to deal with the identical configurations.

As illustrated in FIG. 4, the remover devices 30 for the present embodiment each include a case 31 having an air introducing port 311 on an upper face thereof and an air discharge port 312 on a lower portion of a side face thereof on the far side in the width direction W. The remover devices 30 each include in its case 31 a primary filter element 321, a secondary filter element 322, and a tertiary filter element 323 arranged sequentially from near the air introducing port 311 downward to allow passage therethrough of air containing coating material mist as introduced through the air introducing port 311.

The lower chamber 44 for the present embodiment is provided with an upstream collection duct 48 suspended from a top face thereof and coupled to the upstream connection ports 46. The lower chamber 44 includes on a side face on the outer side (that is, the far side) in the width direction W a discharge port 441 and a downstream duct 49 connected thereto. The coating apparatus 10 includes a gas discharge fan F with a primary side to which the discharge port 441 is connected. The remover devices 30 at the operating position have their respective air introducing ports 311 coupled to a single upstream collection duct 48 and their respective air discharge ports 312 coupled to a single downstream duct 49.

The coating apparatus 10 as the present embodiment, which is configured as above, sends air containing coating material mist through a first connection path 41 (which includes the upstream flow path 431, the upstream connection ports 46, and the upstream collection duct 48) and through the respective air introducing ports 311 into the remover devices 30. The coating apparatus 10 causes the air containing coating material mist to flow in each remover device 30 from above to below through the primary, secondary, and tertiary filter elements 321, 322, and 323 to remove coating material mist. The coating apparatus 10 causes the air, from which coating material mist has been removed, to be discharged from the respective air discharge ports 312 of the remover devices 30, flow through a second connection path 42 (which includes the downstream duct 49), and be discharged from the coating apparatus 10 through the discharge port 441.

The coating apparatus 10 as the present embodiment is also configured such that, as illustrated in FIG. 5, a worker is able to move a remover device 30 to a non-operating position in the lower space 40 for maintenance work such as replacement of the filter elements 321, 322, and 323.

The present embodiment may be altered such that the remover devices 30 each have an air discharge port 312 not on a side face of its case 31 but on the lower face thereof. In this case, each lower chamber 44 includes on its lower face a discharge port 441 for discharging air from the coating apparatus 10 and a downstream duct 49 connecting the discharge port 441 to the air discharge ports 312.

The description above has dealt with the features of the coating apparatus 10 as Embodiment 1 or 2. The description below deals with how the features are advantageous.

The coating apparatus 10 as Embodiment 1 or 2 includes a path for mist-containing air from the coating booth 20 to each remover device 30 (that is, a first connecting passage 41) that is nonlinear with a relatively large resistance to airflow. Thus, if the amount of air that each remover device 30 processes is decreased by, for example, a clog in the filter elements 321, 322, and 323, the effect on the airflow in the coating booth 20 is mitigated, and unlikely disturbs the airflow.

The remover devices 30 in each coating zone Z1, Z2, Z3, . . . are connected to an opening 26 in the coating booth 20 through a single common first connection path 41. This allows a decrease in the amount of air that a remover device 30 processes to be offset by other remover devices 30, and thereby prevents such a decrease from affecting airflow in the coating booth 20.

The remover devices 30 are each only on one side in a lower space 40 relative to the imaginary center line C of the coating apparatus 10. This allows that portion of the lower space 40 which is on the other side to be used for, for example, maintenance of the remover devices 30, and thereby eliminates the need for space for maintenance of the remover devices 30 further on the outer side in the width direction W than the lower space 40. The coating apparatus 10 thus requires only a small area for its installation.

The remover devices 30 each include primary, secondary, and tertiary filter elements 321, 322, and 323 collectively in its case 31 and arranged in the width direction W. This means a smaller height for a flow path for air containing coating material mist than in the case of vertically arranged, separate spaces for respective filter elements. The above configuration thus reduces that portion of the flow path which the worker is unable to easily reach, and thereby facilitates maintenance of the flow path. The above configuration also allows the worker to move the filter elements 321, 322, and 323 together, and thereby facilitates maintenance thereof.

Each upstream flow path 431 is shaped to have a varying cross-sectional area. This allows a turbulent flow such as a swirl to be generated to cause a larger amount of coating material mist to come into contact with and adhere to a wall face. This in turn reduces coating material mist contained in air to be introduced into the remover devices 30, and thereby reduces coating material mist adhering to the filter elements 321, 322, and 323, with the result of a longer service life for the filter elements 321, 322, and 323.

1. A coating apparatus, comprising:
a coating booth configured to coat with a coating material a coating target being conveyed, the coating booth having an opening disposed in a portion of a lower face of the coating booth and configured to discharge air containing coating material mist, wherein the portion is central in a width direction of the coating booth, the width direction is horizontally orthogonal to a direction in which the coating target is conveyed;
at least one remover device disposed below the coating booth and within an area of the coating booth in the width direction and configured to receive from the coating booth the air containing the coating material mist and remove the coating material mist; and
a first connection path connecting the opening to the at least one remover device, and
wherein the at least one remover device comprising an air introducing port is disposed outward of the opening in the width direction, is connected to the first connection path, and is configured to receive from the first connection path the air containing the coating material mist.

2. The coating apparatus according to claim 1,
wherein the coating apparatus causes the air to flow inward from outward in the width direction in the at least one remover device.

3. The coating apparatus according to claim 2,
wherein the at least one remover device comprises an air discharge port disposed on an upper face of the at least one remover device and configured to discharge the air from which coating material mist has been removed, and
the coating apparatus further comprising:
a gas discharge fan configured to discharge, from the coating apparatus, air discharged from the air discharge port;
a second connection path connecting the air discharge port to the gas discharge fan; and
a partition wall separating the first connection path from the second connection path.

4. The coating apparatus according to claim 3,
wherein the partition wall comprises an airflow guide configured to guide, outward in the width direction, the air containing the coating material mist which air has been discharged from the opening.

5. The coating apparatus according to claim 1,
wherein the air introducing port is on an upper face of the at least one remover device.

6. The coating apparatus according to claim 5,
wherein the at least one remover device comprises an air discharge port disposed on a lower face of the at least one remover device or on a side face of the at least one remover device in the width direction and configured to discharge the air from which coating material mist has been removed, and
the coating apparatus further comprising:
a gas discharge fan configured to discharge, from the coating apparatus, air discharged from the air discharge port; and
a second connection path connecting the air discharge port to the gas discharge fan.

7. The coating apparatus according to claim 6, further comprising:
an airflow guide configured to guide, outward in the width direction, the air containing the coating material mist which air has been discharged from the opening.

8. The coating apparatus according to claim 1,
wherein the at least one remover device comprises a filter element comprising a cardboard filter.

9. The coating apparatus according to claim 1,
wherein the at least one remover device is movable in the width direction between an operating position and a non-operating position in an area of the coating booth,
wherein when the at least one remover device moves to the operating position, the air introducing port is connected to the first connection path, and
wherein when the at least one remover device moves to the non-operating position, the air introducing port is apart from the first connection path.

10. The coating apparatus according to claim 9,
wherein the operating position and the non-operating position are opposite to each other across an imaginary center line of the coating booth in the width direction.

11. The coating apparatus according to claim 1,
wherein the first connection path comprises, between an area on a side of the opening and an area on a side of the air introducing port, an area with a cross-sectional area different from a cross-sectional area of at least either the area on the side of the opening or the area on the side of the air introducing port.

12. The coating apparatus according to claim 1,
wherein the at least one remover device comprises a plurality of remover devices arranged in the conveyance direction, and
wherein the first connection path connects the opening to the respective air introducing ports of the plurality of remover devices.
